(19) United States
(12) Patent Application Publication
(10) Pub. No.: US 2014/0330683 A1
(43) Pub. Date: Nov. 6, 2014

(54) Method of Selling Mobile Phone Accessories in a Vending Machine

(71) Applicant: Erik J. Knight, Phoenix, AZ (US)

(72) Inventor: Erik J. Knight, Phoenix, AZ (US)

(21) Appl. No.: 13/886,949

(22) Filed: May 3, 2013

Related U.S. Application Data
(63) Continuation-in-part of application No. 13/886,232, filed on May 2, 2013.

(51) Int. Cl. G06Q 30/06

(52) U.S. Cl. CPC G06Q 30/0641
USPC 705/27.1

(57) ABSTRACT

The invention relates to a method of dispensing a number of mobile phone accessory products from a vending machine by use of a uniform, standardized package. The vending machine may have a number of shelves and a number of individual column on each shelf. The user selects a product to be purchased by shelf and column, and the vending machine delivers the selected product by a mechanical operation to a receptacle where the user obtains the purchased product. The vending machine keeps track of inventory as well as purchasing remotely. Also, the vending machine is capable of referral to a website where the user obtains additional information on which phone the user has so the proper selection can be made.

### CROSS REFERENCE TO RELATED APPLICATIONS

This application is a continuation in part of U.S. application Ser. No. 13/886,232, now pending, filed on May 2, 2013. The entire prior application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed toward the sales of phone accessories in a vending machine by use of enclosing the phone accessories in a standard uniform package or container.

(2) Description of Related Art

Many vending machines have a front door with a glass to allow a potential customer to see the products stored within. Such a windowed door allows for storing the products in a first in, first out (“FIFO) fashion and also allows for the product aesthetics to be viewed. Such FIFO rotation ensures that the products therein are dispensed in a timely and efficient manner. Further, glass front venders allow the customer (or consumer) to select among the presented products by location. That is, by selecting a row and column as in a grid format.

Some moderately higher end products are currently sold in malls and other ‘in store areas’ where a vendor provides a boutique product on an island sales platform where the specialized item does not justify the renting out a store space. These types of products are expensive enough and profitable enough to be sold with the assistance of a salesperson who attends the booth and often provides a minimal amount of assistance.

Mobile phone accessories are one of the items commonly sold on an island platform. They are a higher end product and specialized in the sense that they require that the sales person have some minimal knowledge about mobile phones, and provide assistance to consumers about what products are applicable to their phone.

A salesperson can confirm a few basic facts that are important to the consumer such as:

1. The product will fit (such as an outer decorative case) or is suitable for their phone model

2. Answer basic questions about product specifications—in detail if asked for.

3. Take a return product if defective or unsatisfactory.

A vending machine could potentially replace the island sales platform if important consumer issues can be addressed such as

1. Answering technical questions

2. Being able to see what is being offered

3. Being able to complete a transaction

4. Having confidence that the product purchased is suitable for their mobile phone

5. Maintaining inventory in the vending machine

6. Obtain detailed information about the product

7. Having a method to return the product, such as a sales receipt

Some common mobile phone accessories that are saleable in a vending include: decorative cases, ear buds, music gift cards, 110 VAC charging cords, blue tooth items, communication cables, automotive charging cords, and the like. The consumer can purchase these items with little or no technical assistance from a salesperson if their questions are answerable via a self-help methodology, such as an accessible website, and the consumer can proceed with a self-initiated vending machine sales transaction.

One particular issue is assisting the user in identifying their type of phone. Surprisingly, it is a frequent issue that potential customers are unable/not confident of which type of phone (i.e. manufacturer or model number) they are using. Though the manufacturer name may be stamped on the back of their phone (or available somewhere in the phone software), it is common for the user to be unsure of which exact phone type or model they have. This lack of confidence for those that are unsure is a significant barrier to potential sales.

Another difficulty to selling mobile phone accessories in a vending machine is lack of a uniform outer package or container. It is difficult to design a vending machine for a variety of products where the products can be dispensed reliably if the package/shape of the dispensed item is non-uniform.

It is also of interest to the vending machine supplier to keep track of inventory and sales. Although it is possible to check the vending machine on a frequent basis by visiting a machine in person on a schedule, it is an undesirable method. Also, if a fashion accessory is being sold (such as a mobile phone outer case) it is difficult to keep track of trends and have the correct inventory in stock. Sales are lost while trying to keep up with current trends. It is important for a successful operation from a supplier standpoint and to some extent for a buyer's perspective, for the inventory to optimally match the desire of the customer. To that end, it is desirable for the inventory to be tracked by a remote means.

There is a potential market, therefore, for improved a vending machine designed and tailored specifically for the needs of a mobile phone market. The vending machine also preferably displays the products in a prominent and attractive manner so as to gain the consumer's attention and interest.

A vending machine is needed to affordably and economically service this market, and needs to address the issues identified.

### BRIEF SUMMARY OF THE INVENTION

A standardized outer container is designed to house mobile phone accessory products and delivered via a vending machine. The vending machine is self-contained and provides important information to the consumer about their potential purchase. To ensure the user is knowledgeable about their phone type, they are informed by either a scan-able bar code directing them to a web site that will automatically detect their phone type, or they can compare their phone to a picture. The unified, standardized outer package provides a basis for a reliable vending machine delivery system. Payments can be made by electronic methods such as by a purchasing card, credit card, bank card, an electronic funds transfer, or by a cash payment. Inventory is done by a remote monitoring system.

### BRIEF DESCRIPTION OF THE SEVERAL VIEWS OF THE DRAWING(S)

FIG. 1 shows the front of a vending machine designed to dispense mobile phone accessory products.

FIG. 2 shows the side of the vending machine in FIG. 1 if a second similar vending machine is back to back with the vending machine in FIG. 1.

FIG. 3 shows a uniform outer package housing a mobile phone case used in FIG. 1.

FIG. 4 shows the front right side door open of the vending machine in FIG. 1 to show important components.

### DETAILED DESCRIPTION OF THE INVENTION

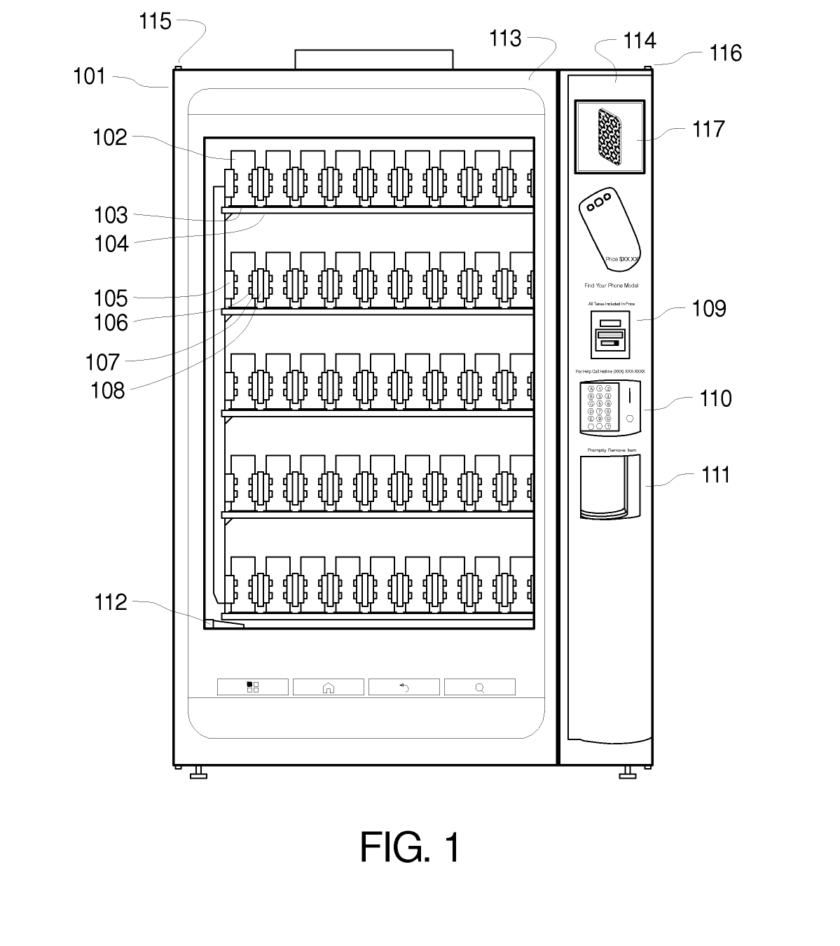

In FIG. 1, the vending machine 101 includes a left front door 113 (left door hinges 115) and a right front door 114 (right door hinges 116). The left front door 113 has a panel made of glass or other transparent material to allow the consumer to see the products on display for purchase. The vending machine 101 includes a product end dispenser 111. The consumer grasps and pulls the dispensed product out after it is placed in the product end dispenser 111. More than one product end dispenser can be used. The vending machine 101 includes a selection panel or product selector 110. The product selector panel 110 is an alpha numeric keypad which the consumer uses to select the particular row and column of the product. For example, the product in the upper left corner would be A1 and the product in the lower right corner would be E9. Where the letter represents the horizontal row and the number is the column counting from the left. Alternately, the row is a number and the column is a letter. The correct alphanumeric number is preferably displayed underneath each product to aid in helping the consumer understand which numeric code to key in.

To purchase a packaged product 102, the consumer selects an item on the product selector using the alpha numeric keypad on the product selector panel 110. The alphanumeric keypad is used to select a product shelf 104 (i.e. row) and a product column in any order. The amount for the item appears on the cash/money sales device 109 and the consumer pays for the item by supplying a credit card, debit card, cash, or other acceptable payment. The vending machine verifies the payment and then moves the product transfer unit 112 to the correct row and column. The moving side tab 106 and moving side tab support 107 are then activated to withdraw horizontally (i.e. narrow) which allows the purchased product to pass forward into the product transfer unit. The center fixed tab support 108 holds the moving side tab and moving side tab support. The center fixed tab support 108 does not narrow and is fixed in place. A moving transfer conveyor 103 under the product moves the product forward into the product transfer unit 112. The product transfer unit then moves downwardly and to the right to dispense the selected product into the product end dispenser 111 where the consumer may grasp it from the vending machine. The moving transfer conveyors 103 under each product column are supported by fixed product shelves 104.

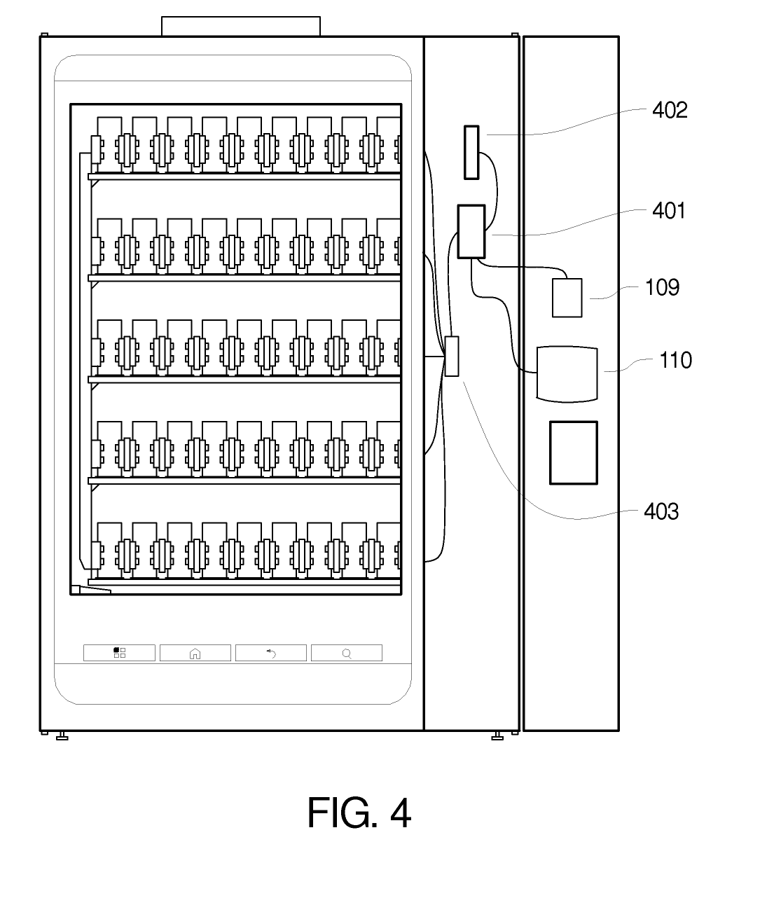

When the mobile phone accessory product is dispensed, a sensor (see FIG. 4) monitors the product end dispenser 111 to ensure that the product is successfully moved from the product shelf to the consumer. This verifies that the machine has performed satisfactorily and ensures that the customer receives the item before billing occurs. There is a door in the product end dispenser which opens for the customer to obtain the item and then closes to prevent vending machine tampering.

In an alternate embodiment, the vending machine utilizes a horizontal shelf and dispenses products only by moving product forward onto the shelf and lowering the shelf to a dispensing area where the consumer may grasp the product.

In a preferred embodiment, a touch monitor 117 is available for the consumer's viewing. The monitor provides three important services:

1. A display of the product selected.

2. A display of how the selected product will look like when it is used with the consumer's phone. This is especially helpful when a decorative phone case is selected.

3. A display of the consumer's phone type.

The monitor is preferably touch screen or alternately it is accessible through a consumer interface such as a keypad. In a preferred embodiment, the display shows the products from various angles and includes a rotatable view showing the mobile phone accessory product for a full 360 degree rotation about at least one axis.

The operation of the vending machine is controlled by a microprocessor type of controller. The controller is preferably a programmable microprocessor or similar computerized system that includes a CPU, memory, hard drive or flash drive storage, user interface, input and outputs, communication with vending machine components, and a consumer display. Preferably the microprocessor uses a wireless device, a cell phone system communication device, internet connection, or similar electronic communication device to remotely communicate with the vending machine operator for the purpose supplying information related to the vending machine condition, inventory, error codes, etc.

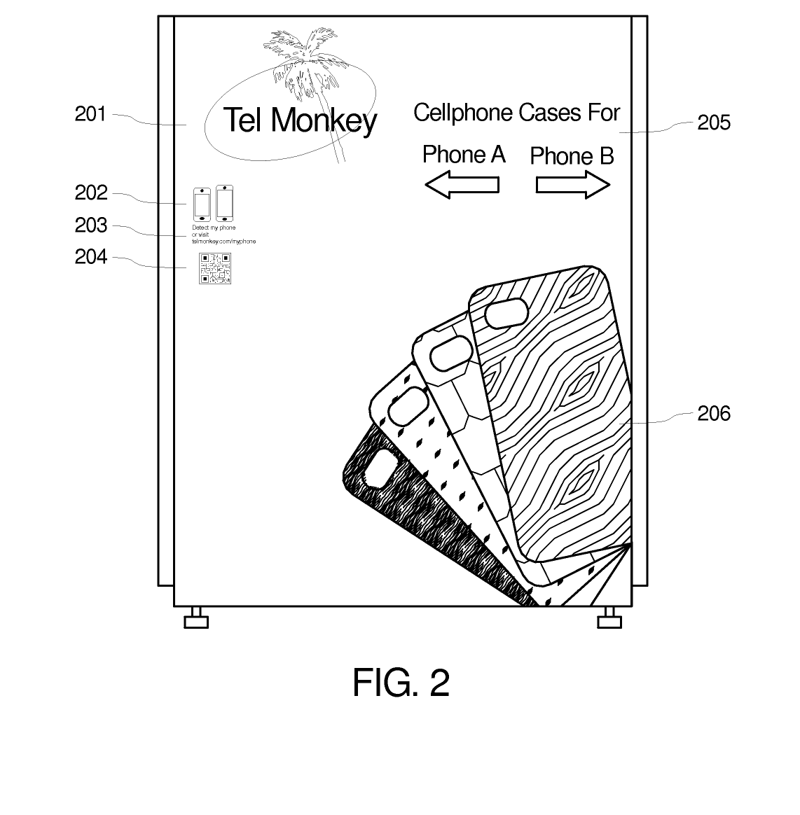

FIG. 2 shows the side of the vending machine in FIG. 1. The company logo 201 is prominently displayed. As seen, pictures of popular mobile phones 202 are used to identify the particular type of phone the consumer is using along with instructions of how the consumer's phone type can be detected 203. In another embodiment, a phone number (not shown) is available to call so that the consumer may find out (via an automated system) which type of phone the consumer is using. Finally, a website is accessible by using a standardized bar code 204 that provides the user access to information about their phone/operating system so that the consumer may be informed as to which phone they are holding. It should be noted that the automated systems of phone detection only work if the phone permits identification. If there is a user privacy setting, or an operating system setting that prevents identification, the consumer will have to be directed to the settings on their phone so they can identify their phone type by accessing the features of their phone. Additional space on the side(s) is available for advertising and product promotion 206.

In the case that two vending machines are placed back to back, and are additionally set up to dispense accessories two different phone systems, a direction information area 205 informs the consumer as to which vending machine is to be used for which phone.

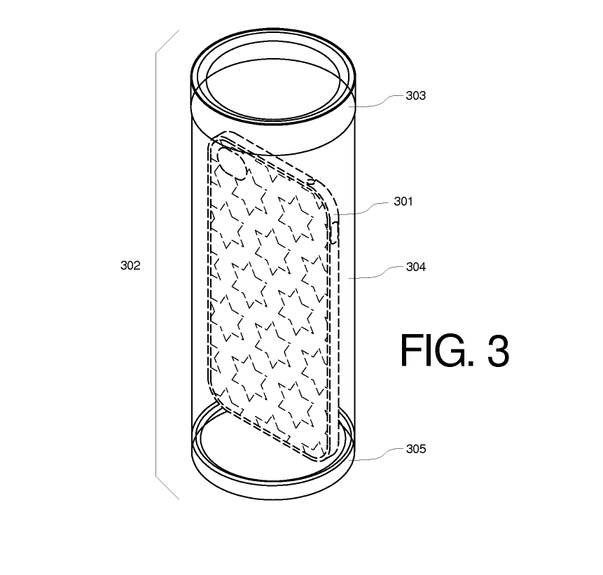

FIG. 3 shows a uniform outer package (or container) as seen previously in FIG. 1 which is housing a mobile phone case. In this example, a mobile phone case 301 is housed inside a transparent uniform outer cylinder package 302 comprising a cylinder top 303, cylinder middle 304, and cylinder bottom 305. The uniform outer cylinder package is preferably made from a disposable transparent material so that the consumer will easily see what product is being purchased. The cylinder bottom is preferably glued or pressed into the cylinder middle, while the cylinder top is a tight or tolerance fit so as to allow a consumer to easily pull it off. A wide variety of mobile phone accessory products will fit inside this package shape.

FIG. 4 shows the front right side door open of the vending machine in FIG. 1. A microprocessor 401 communicates with the consumer keypad interface 110, a payment device 109, a remote electronic communication module 402, and an input/output module 403. An input/output module communicates with the machine components of the vending machine and so as to actuate the motors, solenoids, etc. to move the product from the inventory location to the dispensing area. It also receives input from sensors as needed to verify motion and dispensing of the product. It also provides convenience lighting, handles advertising needs, performs administrative functions such as inventory (and item out of stock), and provides consumer instructions. The microprocessor incorporates a CPU, memory, hard drive storage or flash drive storage, operator interface, and remote communication as previously described. In another embodiment, the input/output module and the CPU could equally be incorporated onto a single printed circuit board.

The lighting in the vending machine may be selected from a number of available commercially lighting bulbs. In a preferred embodiment, a cool white LED color, 6000+ degrees Kelvin is used. This is a bluish white light and displays the products attractively. The lighting may be in strips, tube, strings, or individual bulbs.

This color has been observed to be better in initial testing, as it makes the products appear more attractive. In particular, phone cases are considered to be more eye catching using this kind of lighting. Initial vending machine installations have been successful in obtaining satisfactory sales levels using this type of lighting.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A method of dispensing a selected mobile phone accessory product from a vending machine to a consumer from a variety of mobile phone accessory products on display comprising:
a) providing a plurality of product shelves identified by a first alphanumeric character,
b) providing a plurality of product columns of product identified by a second alphanumeric character,
c) providing a dispensing area on the front of said vending machine,
d) providing a consumer interface which is used for product selection by said product shelf and by said product column,
e) providing a product transfer unit within said vending machine which moves a selected mobile phone accessory product to said dispensing area,
f) providing a plurality of uniform containers, wherein said uniform containers house said mobile phone accessory products,
g) providing a payment device, and
h) wherein said consumer
i) uses said consumer interface to select said selected mobile phone accessory product,
ii) pays for said selected mobile phone accessory product by use of said payment device, and
iii) receives said selected mobile phone accessory product in said dispensing area.

2. The method of dispensing a selected mobile phone accessory product according to claim 1 wherein said payment device is capable of accepting credit card, cash, or debit card.

3. The method of dispensing a selected mobile phone accessory product according to claim 1 wherein the inventory of said vending machine is monitored remotely.

4. The method of dispensing a selected mobile phone accessory product according to claim 1 wherein the status of said vending machine is monitored remotely.

5. The method of dispensing a selected mobile phone accessory product according to claim 1 wherein said uniform containers are transparent cylinders.
